(19) United States
(12) Patent Application Publication
(10) Pub. No.: US 2013/0246347 A1
(43) Pub. Date: Sep. 19, 2013

(54) DATABASE FILE GROUPS

(71) Applicants: Ellen L. Sorenson, Mounds View, MN (US); Roger V. Ritchie, Colorado Springs, CO (US)

(72) Inventors: Ellen L. Sorenson, Mounds View, MN (US); Roger V. Ritchie, Colorado Springs, CO (US)

(21) Appl. No.: 13/420,947

(22) Filed: Mar. 15, 2012

(51) Int. Cl. G06F 17/30

(52) U.S. Cl. 707/609; 707/821; 707/E17.01; 707/E17.005

(57) ABSTRACT

Files may be assigned to groups for processing in an efficient manner. For example, a group may include a list of file names for processing together. The file names are assigned to the group by a user. When a command is executed on the system for modifying a file, the group name is provided along with the command rather than the file name or list of individual file names. The command automatically executes repeatedly for each file name associated with the group name.

The instant disclosure relates to a computer system. More specifically, this disclosure relates to executing commands within a computer system.

### BACKGROUND

Computer systems execute commands nearly continuously. Many of those commands are input manually by a user to the computer system, such as through a command prompt. Command execution is generally serial in nature, such that a user inputs one command, waits for the execution of the command to complete, and then input another command. FIG. 1 is a flow chart illustrating a conventional method for processing commands. A method 100 begins at block 102 with receiving a command and a file name at block 102. At block 104, the command is executed on the file identified by the file name. The method 100 repeats back to block 102 to receive another command.

The method 100 of command execution illustrated in FIG. 1 is inefficient, because commands are often repeated multiple times for different files. In fact, the number of commands available is usually very small in comparison to the number of files stored on a computer system. For example, there may be only fifteen commands but thousands of files. Thus, it is likely that certain commands are entered for the same list of different files in rapid succession. When certain files on a computer system are related, the likelihood of a command being executed multiple times sequentially on different files further increases. However, the command is still required to be entered multiple times in a conventional method of executing commands.

One solution for increasing efficiency of the method 100 is to allow lists of files to be entered after a command. For example, a list of filenames may be passed as arguments to a command: “delete file1 file2 file3 file4.” In this solution command is entered with multiple file names at block 102. At block 104, the command is executed on the first listed file name. At block 106, the method 100 repeats block 104 for each file name in the list of file names. However, this solution involves entering the list of files each time the list of files should be acted upon by a command. Thus, another solution for handling execution of commands with groups of files is needed.

### SUMMARY

According to one embodiment, a method includes receiving a command and a group identifier. The method also includes identifying a collection of files associated with the group identifier. The method further includes executing the command for each file of the collection of files.

According to another embodiment, a computer program product includes a non-transitory computer readable medium having code to receive a command and a group identifier. The medium also includes code to identify a collection of files associated with the group identifier. The medium further includes code to execute the command for each file of the collection of files.

According to a further embodiment, an apparatus includes a memory and a processor coupled to the memory. The processor is configured to receive a command and a group identifier. The processor is also configured to identify a collection of files associated with the group identifier. The processor is further configured to execute the command for each file of the collection of files.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating a conventional method for processing commands.

FIG. 2 is a flow chart illustrating a method for processing commands according to one embodiment of the disclosure.

FIG. 3 is a block diagram illustrating organization of files into groups according to one embodiment of the disclosure.

FIG. 4 is block diagram illustrating a computer network according to one embodiment of the disclosure.

FIG. 5 is a block diagram illustrating a computer system according to one embodiment of the disclosure.

FIG. 6A is a block diagram illustrating a server hosting an emulated software environment for virtualization according to one embodiment of the disclosure.

FIG. 6B is a block diagram illustrating a server hosing an emulated hardware environment according to one embodiment of the disclosure.

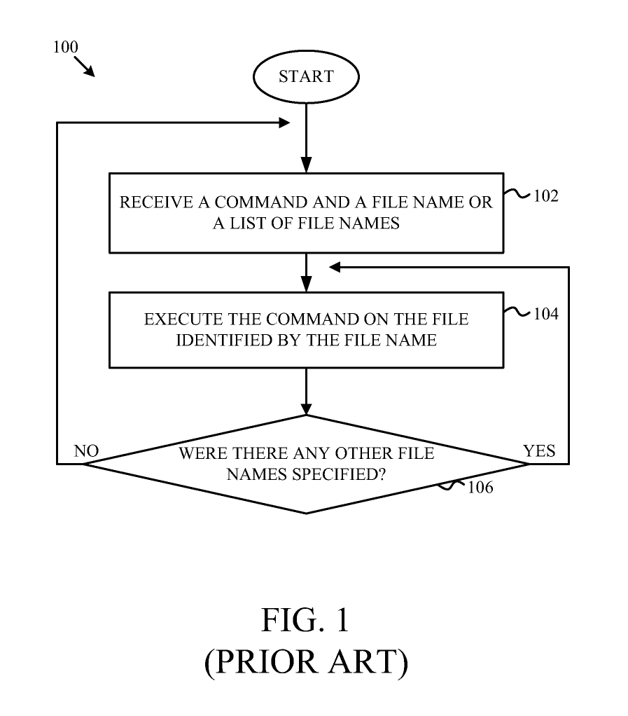

### DETAILED DESCRIPTION

Files within a computer system may be associated into groups, such that a command may be executed with reference to a group. When the command receives a group identifier, instead of a file name or list of file names, the command may be repeatedly executed on each of the files associated with the group identifier. Thus, only a single command may be communicated to the computer system by a user for processing on multiple files. Additionally, a list of files associated with the group may be stored in a single location in memory, rather than as separate lists scattered across a storage system. The use of a group reduces maintenance associated with updating multiple lists of files when the list of files is updated.

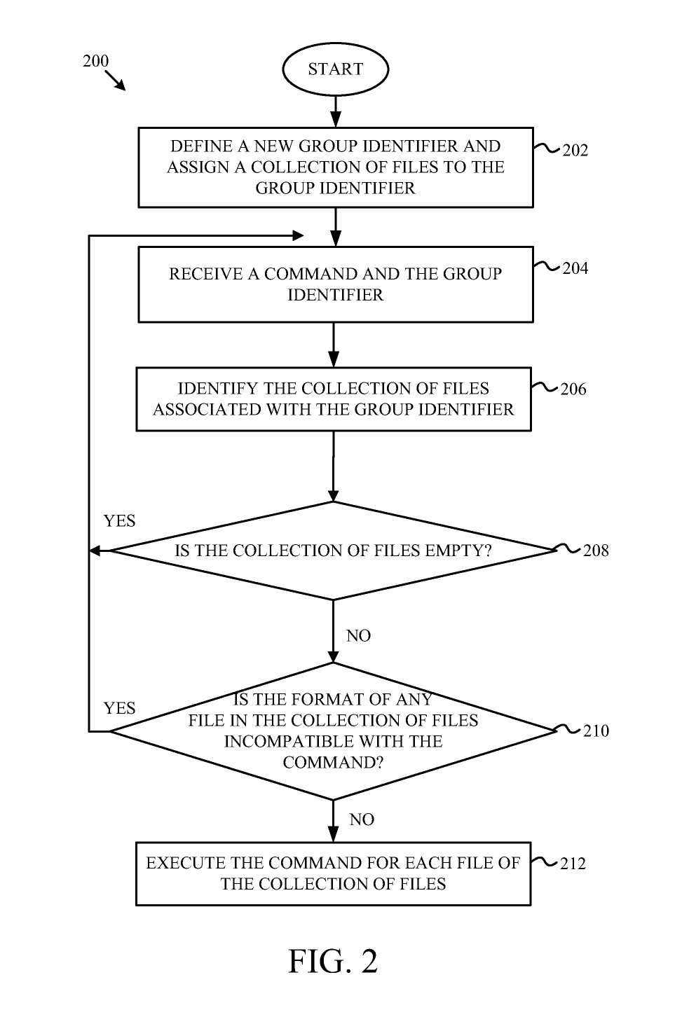

FIG. 2 is a flow chart illustrating a method for processing commands according to one embodiment of the disclosure. A method 200 begins at block 202 with defining a new group identifier and assigning a collection of files to the group identifier. The group identifier may be selected by the user. However, certain group identifiers may be made unavailable to the user and reserved for system functions. For example, group identifiers matching a command name may be prohibited for selection by a user. In another example, group identifiers such as “SYSTEM” or “CONFIG” may be reserved for system use.

Group identifiers may be operated on by several commands. A “DEFINE GROUP” command may establish the name of a new group and create data structures in storage to store file names associated with the group identifier. A “DELETE GROUP” command may delete a specified group identifier. A “REPORT GROUP” command may display a list of defined group identifiers and the files associated with each group identifier. An “INSERT” command may associate one or more file names into a defined group identifier. When associating a file name with a group identifier, an order may be specified for the file names in the group. A default arrangement may sort the file names in chronological order. The file for association with the group identifier may be specified by a file name, including a file number, or a specific location on a drive. A “REMOVE” command may remove a file name from association with a defined group identifier. Files may be a member of one or more groups.

At block 204, a command and a group identifier is received. The group identifier may have been previously defined at block 202. According to one embodiment, the command name is identical whether a single file, list of files, or a group identifier is provided with the command. According to another embodiment, separate command names may be assigned for executing a command on a collection of files. For example, when a command is “DELETE” an identical command of ‘DELETEGROUP” may be created on the computer system for execution with a group. Other commands may include clear, collect, delete, disable, down, dump, dump changes, enable, list, print, recover, reload, replicate, report, set, and up. These commands are examples of commands used to backup, restore, and maintain a database.

At block 206, the collection of files associated with the group identifier are identified. The association of files with groups may be stored in a database or a file stored on the computer system. According to one embodiment, the association of groups with files may be stored in a dump history file or a relational database management system (RDMS).

At block 208, the collection of files associated with the group identifier is examined to determine if the collection of files is empty. For example, a group may be defined but have no files associated with the group. If no files are associated with the group identifier, then the method 200 return to block 204 by stopping execution of the command received at block 204 and waiting for another command. The computer system may also report an error to the user or log an error in a system log file or database.

At block 210, the collection of files is inspected to ensure each of the files associated with the group identifier is compatible with the command issued. Certain files may be incompatible with a command. For example, a command to “REPORT” a binary file rather than a text file may not be supported for a text terminal interface. According to one embodiment, if any file of the collection of files associated with the group identifier is incompatible with the command, then execution of the command may be terminated and flow of the method 200 returned to block 204 to wait for another command. According to another embodiment, files in the collection of files compatible with the command may be executed and only execution of the files incompatible with the command may be halted. Whether to continue execution of the command with compatible files or halt execution completely may be an option available to the user entering the command. For example, a parameter may be attached to the command, such as “ON ERROR CONTINUE” instructing the computer system to execute the command on all files compatible with the command.

At block 212, the command is executed for each file of the collection of files or on each compatible file of the collection of files depending on the outcome of block 210. According to one embodiment, the command may execute on a collection of files associated with the group identifier in a sequential manner defined by an order of the file names created when the file names are associated with the group identifier at block 202.

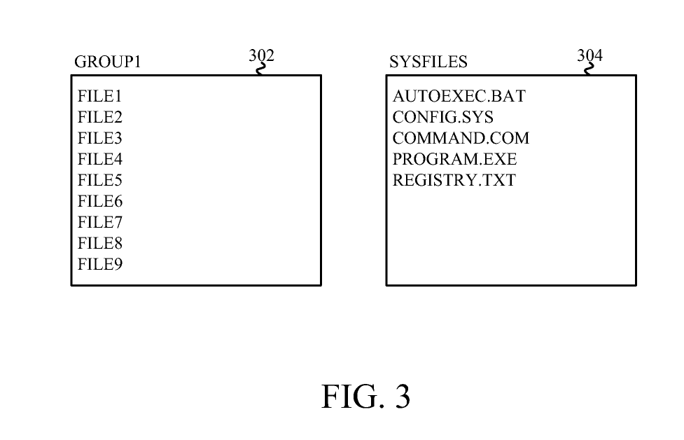

FIG. 3 is a block diagram illustrating organization of files into groups according to one embodiment of the disclosure. A first group 302 may include a number of files. A second group 304 may also include a number of files. The groups 302 and 304 may each include a listing of files that are similar according to at least one characteristic. For example, the group 304 may include system files, such as autoexec.bat, config.sys, and command.com. In another example, a group may include a listing of files pertaining to one user of the system. In yet another example, a group may include a, listing of files pertaining to one application installed on the system. Groups with files related according to characteristics other than content may be created. For example, a group may include files larger than a particular size, such as 1 gigabyte (GB). In another example, a group may include files modified on a particular date. However, the groups 302 and 304 may also be arbitrarily defined.

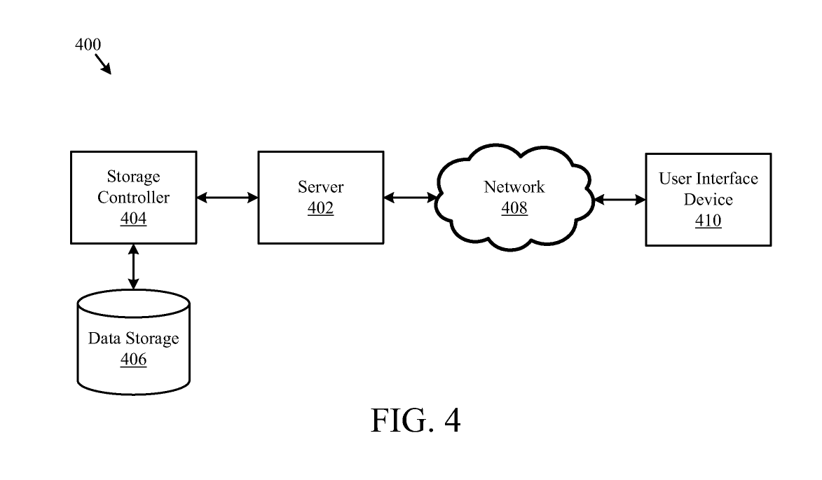

FIG. 4 illustrates one embodiment of a system 400 for an information system. The system 400 may include a server 402, a data storage device 406, a network 408, and a user interface device 410. The server 402 may be a dedicated server or one server in a cloud computing system. In a further embodiment, the system 400 may include a storage controller 404, or storage server configured to manage data communications between the data storage device 406 and the server 402 or other components in communication with the network 408. In an alternative embodiment, the storage controller 404 may be coupled to the network 408.

In one embodiment, the user interface device 410 is referred to broadly and is intended to encompass a suitable processor-based device such as a desktop computer, a laptop computer, a personal digital assistant (PDA) or tablet computer, a smartphone or other a mobile communication device having access to the network 408. When the device 410 is a mobile device, sensors (not shown), such as a camera or accelerometer, may be embedded in the device 410. When the device 410 is a desktop computer the sensors may be embedded in an attachment (not shown) to the device 410. In a further embodiment, the user interface device 410 may access the Internet or other wide area or local area network to access a web application or web service hosted by the server 402 and provide a user interface for enabling a user to enter or receive information.

The network 408 may facilitate communications of data, such as authentication information, between the server 402 and the user interface device 410. The network 408 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 410 accesses the server 402 through an intermediate sever (not shown). For example, in a cloud application the user interface device 410 may access an application server. The application server fulfills requests from the user interface device 410 by accessing a database management system (DBMS). In this embodiment, the user interface device 410 may be a computer or phone executing a Java application making requests to a JBOSS server executing on a Linux server, which fulfills the requests by accessing a relational database management system (RDMS) on a mainframe server.

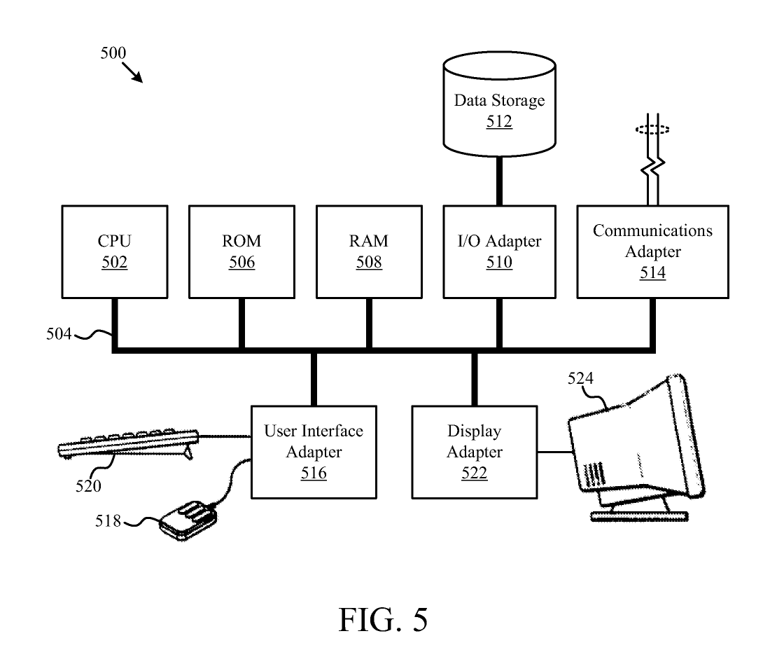

FIG. 5 illustrates a computer system 500 adapted according to certain embodiments of the server 402 and/or the user interface device 410. The central processing unit (“CPU”) 502 is coupled to the system bus 504. The CPU 502 may be a general purpose CPU or microprocessor, graphics processing unit (“GPU”), and/or microcontroller. The present embodiments are not restricted by the architecture of the CPU 502 so long as the CPU 502, whether directly or indirectly, supports the operations as described herein. The CPU 502 may execute the various logical instructions according to the present embodiments.

The computer system 500 also may include random access memory (RAM) 508, which may be synchronous RAM (SRAM), dynamic RAM (DRAM), synchronous dynamic RAM (SDRAM), or the like. The computer system 500 may utilize RAM 508 to store the various data structures used by a software application. The computer system 500 may also include read only memory (ROM) 506 which may be PROM, EPROM, EEPROM, optical storage, or the like. The ROM may store configuration information for booting the computer system 500. The RAM 508 and the ROM 506 hold user and system data.

The computer system 500 may also include an input/output (I/O) adapter 510, a communications adapter 514, a user interface adapter 516, and a display adapter 522. The I/O adapter 510 and/or the user interface adapter 516 may, in certain embodiments, enable a user to interact with the computer system 500. In a further embodiment, the display adapter 522 may display a graphical user interface (GUI) associated with a software or web-based application on a display device 524, such as a monitor or touch screen.

The I/O adapter 510 may couple one or more storage devices 512, such as one or more of a hard drive, a solid state storage device, a flash drive, a compact disc (CD) drive, a floppy disk drive, and a tape drive, to the computer system 500. According to one embodiment, the data storage 512 may be a separate server coupled to the computer system 500 through a network connection to the I/O adapter 510. The communications adapter 514 may be adapted to couple the computer system 500 to the network 408, which may be one or more of a LAN, WAN, and/or the Internet. The communications adapter 514 may also be adapted to couple the computer system 500 to other networks such as a global positioning system (GPS) or a Bluetooth network. The user interface adapter 516 couples user input devices, such as a keyboard 520, a pointing device 518, and/or a touch screen (not shown) to the computer system 500. The keyboard 520 may be an on-screen keyboard displayed on a touch panel. Additional devices (not shown) such as a camera, microphone, video camera, accelerometer, compass, and or gyroscope may be coupled to the user interface adapter 516. The display adapter 522 may be driven by the CPU 502 to control the display on the display device 524. Any of the devices 502-522 may be physical, logical, or conceptual.

The applications of the present disclosure are not limited to the architecture of computer system 500. Rather the computer system 500 is provided as an example of one type of computing device that may be adapted to perform the functions of a server 402 and/or the user interface device 410. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 600 may be virtualized for access by multiple users and/or applications.

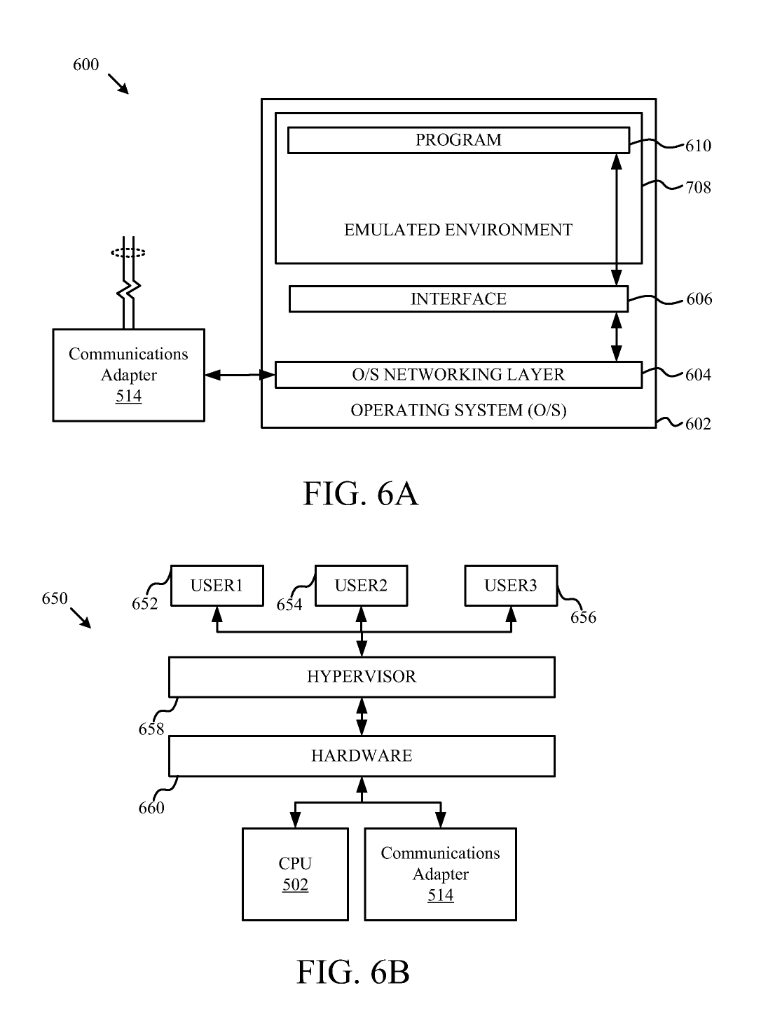

FIG. 6A is a block diagram illustrating a server hosting an emulated software environment for virtualization according to one embodiment of the disclosure. An operating system 602 executing on a server includes drivers for accessing hardware components, such as a networking layer 604 for accessing the communications adapter 514. The operating system 602 may be, for example, Linux. An emulated environment 608 in the operating system 602 executes a program 610, such as CPCommOS. The program 610 accesses the networking layer 604 of the operating system 602 through a non-emulated interface 606, such as XNIOP. The non-emulated interface 606 translates requests from the program 610 executing in the emulated environment 608 for the networking layer 604 of the operating system 602.

In another example, hardware in a computer system may be virtualized through a hypervisor. FIG. 6B is a block diagram illustrating a server hosing an emulated hardware environment according to one embodiment of the disclosure. Users 652, 654, 656 may access the hardware 660 through a hypervisor 658. The hypervisor 658 may be integrated with the hardware 660 to provide virtualization of the hardware 660 without an operating system, such as in the configuration illustrated in FIG. 6A. The hypervisor 658 may provide access to the hardware 660, including the CPU 502 and the communications adaptor 514.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving a command and a group identifier;
identifying a collection of files associated with the group identifier; and
executing the command for each file of the collection of files.

2. The method of claim 1, in which the command is at least one of clear, collect, delete, disable, down, dump, dump changes, enable, list, print, recover, reload, replicate, report, set, and up.

3. The method of claim 1, in which the step of executing the command for each file comprises executing the command for each file in an order specified by the collection of files.

4. The method of claim 1, further comprising:
checking a format of each file of the collection of files before the step of executing the command; and
when the format of any file in the collection of files is incorrect for the received command, prevent execution of the command for the file having the incorrect format.

5. The method of claim 1, in which the step of identifying the collection of files comprises looking up the group identifier in at least one of a dump history file and a database.

6. The method of claim 1, further comprising inserting or removing files from the collection of files.

7. The method of claim 1, further comprising
determining a number of files in the collection of files before the step of executing the command; and
when the number of files is zero, prevent execution of the command.

8. A computer program product, comprising:
a non-transitory computer readable medium comprising:
code to receive a command and a group identifier;
code to identify a collection of files associated with the group identifier; and
code to execute the command for each file of the collection of files.

9. The computer program product of claim 8, in which the command is at least one of a command used to backup a database, a command used to restore a database, and a command used to maintain a database.

10. The computer program product of claim 8, in which the medium comprises code to execute the command for each file in an order specified by the collection of files.

11. The computer program product of claim 8, in which the medium further comprises:
code to check a format of each file of the collection of files before the step of executing the command; and
code to prevent execution of the command for the file having the incorrect format when the format of any file in the collection of files is incorrect for the received command.

12. The computer program product of claim 8, in which the medium comprises code to look up the group identifier in at least one of a dump history file and a database.

13. The computer program product of claim 8, in which the medium further comprises code to insert or remove files from the collection of files.

14. The computer program product of claim 8, in which the medium further comprises:
code to determine a number of files in the collection of files before the step of executing the command; and
code to prevent execution of the command when the number of files is zero.

15. An apparatus, comprising:
a memory for storing a database; and
a processor coupled to the memory, in which the processor is configured:
to receive a command and a group identifier;
to identify a collection of files associated with the group identifier; and
to execute the command for each file of the collection of files.

16. The apparatus of claim 15, in which the command is at least one of a command to backup a database, a command to restore a database, and a command to maintain a database.

17. The apparatus of claim 15, in which the processor is configured to execute the command for each file in an order specified by the collection of files.

18. The apparatus of claim 15, in which the processor is further configured:
to check a format of each file of the collection of files before the step of executing the command; and
to prevent execution of the command for the file having the incorrect format when the format of any file in the collection of files is incorrect for the received command.

19. The apparatus of claim 15, further comprising a storage device coupled to the processor, in which the storage device stores a database, and in which the processor is further configured to look up the group identifier in a dump history file.

20. The apparatus of claim 15, in which the processor is further configured to insert or remove files from the collection of files.
